(19) United States
(12) Patent Application Publication
(10) Pub. No.: US 2006/0039245 A1
(43) Pub. Date: Feb. 23, 2006

(54) Digital and analog audio playback apparatus

(75) Inventor: Simone Huang, Tainan (TW)

Correspondence Address: LAW OFFICE OF KENNETH C. BROOKS;Suite 510 F, 6507 Jester Boulevard, P.O. Box 10417, Austin, TX, 78766-1417, US

(73) Assignee: YA HORNG ELECTRONIC CO. LTD

(21) Appl. No.: 11/111,433

(22) Filed: Apr. 21, 2005

(30) Foreign Application Priority Data
Aug. 17, 2004 (TW) 093124665

(51) Int. Cl. G11B 11/00

(52) U.S. Cl. 369/18

(57) ABSTRACT

A digital and analog audio playback apparatus includes a control unit operable in a first mode, where the control unit enables a driving device to drive rotation of a turntable unit such that a record reading device outputs first audio output data corresponding to analog audio data read from a vinyl record on the turntable unit at a first output port, or a second mode, where the control unit enables a disc reading device so as to output second audio output data corresponding to digital audio data read from an optical recording medium at a second output port. Manual rotation of the vinyl record on the turntable unit while the control unit operates in the second mode results in generation of a control signal by a pick-up device. The control unit is responsive to the control signal so as to control reading of the digital audio data from the optical recording medium in order to impart a scratch effect to the second audio output data.

### CROSS-REFERENCE TO RELATED APPLICATION

This application claims priority of Taiwanese Application No. 093124665, filed on Aug. 17, 2004.

### BACKGROUND OF THE INVENTION

1. Field of the Invention

The invention relates to an audio playback apparatus, more particularly to a digital and analog audio playback apparatus.

2. Description of the Related Art

FIG. 1 illustrates a conventional analog audio playback apparatus 12 that includes an audio turntable 121 to be loaded with a vinyl record 11, and a pick-up head 122 for reading analog audio data recorded in the vinyl record 11. In actual use, since a vinyl record contains relatively less analog audio data, a disc jockey is required to replace vinyl records frequently when the audio playback apparatus 12 is in use, thereby resulting in inconvenience.

FIG. 2 illustrates a conventional digital audio playback apparatus 22 that includes a turntable unit 222, which has an operating surface provided with a tactile feel similar to that of a vinyl record on an audio turntable, and a control unit (not shown). During use, the control unit controls output of digital audio data read from an optical disc 21 in response to manually controlled rotation of the turntable unit 222 so as to impart a scratch effect to the digital audio data. Other conventional digital audio playback apparatuses capable of providing a scratch effect had been disclosed in numerous literatures, such as U.S. Pat. No. 6,576,825, and U.S. Publication patent Nos. 2003/0165100A1 and 2003/0223334A1.

FIG. 3 illustrates a conventional digital and analog audio playback apparatus 3 disclosed in U.S. Publication patent No. 2002/0172101A1. In this reference, control panel 371 is operable so as to enable system microprocessor 37 to output only a selected one of digital audio data recorded in an optical disc 321 and analog audio data recorded in a vinyl record 35 on a turntable unit 361.

FIG. 4 illustrates a conventional digital and analog audio playback apparatus capable of providing a mixed audio output of digital and analog audio data that includes the conventional analog audio playback apparatus 12 of FIG. 1, the conventional digital audio playback apparatus 22 of FIG. 2, and a mixer 7. However, the assembly of the apparatuses 12, 22 and the mixer 7 has a large operating space requirement and is inconvenient to use.

### SUMMARY OF THE INVENTION

Therefore, the object of the present invention is to provide a digital and analog audio playback apparatus that can output a selected one or both of analog audio data from a vinyl record and digital audio data from an optical recording medium.

According to one aspect of the present invention, a digital and analog audio playback apparatus comprises:

a housing;

a turntable unit mounted on the housing and adapted to be loaded with a vinyl record;

a driving device for driving rotation of the turntable unit;

a record reading device operably associated with the vinyl record on the turntable unit for generating first audio output data corresponding to analog audio data recorded in and read from the vinyl record;

a disc reading device mounted in the housing, adapted to be loaded with an optical recording medium, and operably associated with the optical recording medium for generating second audio output data corresponding to digital audio data recorded in and read from the optical recording medium;

a pick-up device operably associated with the vinyl record on the turntable unit so as to generate a control signal representative of angular velocity and rotational direction of the vinyl record relative to the housing;

a control unit mounted in the housing and coupled to the driving device, the pick-up device and the disc reading device;

a first output port mounted on the housing and coupled to the record reading device; and

a second output port mounted on the housing and coupled to the control unit;

the control unit being operable in a selected one of a first mode, where the control unit enables the driving device to drive rotation of the turntable unit such that the record reading device outputs the first audio output data corresponding to the analog audio data read from the vinyl record on the turntable unit at the first output port, and a second mode, where the control unit enables the disc reading device so as to output the second audio output data corresponding to the digital audio data read from the optical recording medium at the second output port;

wherein manual rotation of the vinyl record on the turntable unit relative to the housing while the control unit operates in the second mode results in generation of the control signal by the pick-up device that is provided to the control unit;

the control unit being responsive to the control signal when operated in the second mode so as to control reading of the digital audio data from the optical recording medium in order to impart a scratch effect to the second audio output data generated at the second output port.

According to another aspect of the present invention, a digital and analog audio playback apparatus comprises:

a housing;

a turntable unit mounted on the housing and adapted to be loaded with a vinyl record;

a driving device for driving rotation of the turntable unit;

a record reading device operably associated with the vinyl record on the turntable unit for generating first audio output data corresponding to analog audio data recorded in and read from the vinyl record;

a disc reading device mounted in the housing, adapted to be loaded with an optical recording medium, and operably associated with the optical recording medium for generating second audio output data corresponding to digital audio data recorded in and read from the optical recording medium;

a manually-operable rotary wheel mounted rotatably on the housing;

a pick-up device operably associated with the rotary wheel so as to generate a control signal representative of angular velocity and rotational direction of the rotary wheel relative to the housing;

a control unit mounted in the housing and coupled to the driving device, the pick-up device and the disc reading device;

a first output port mounted on the housing and coupled to the record reading device; and

a second output port mounted on the housing and coupled to the control unit;

the control unit being operable in a selected one of a first mode, where the control unit enables the driving device to drive rotation of the turntable unit such that the record reading device outputs the first audio output data corresponding to the analog audio data read from the vinyl record on the turntable unit at the first output port, and a second mode, where the control unit enables the disc reading device so as to output the second audio output data corresponding to the digital audio data read from the optical recording medium at the second output port;

wherein manual rotation of the rotary wheel relative to the housing while the control unit operates in the second mode results in generation of the control signal by the pick-up device that is provided to the control unit;

the control unit being responsive to the control signal when operated in the second mode so as to control reading of the digital audio data from the optical recording medium in order to impart a scratch effect to the second audio output data generated at the second output port.

According to a further aspect of the present invention, a digital and analog audio playback apparatus comprises:

a housing;

a turntable unit mounted on the housing and adapted to be loaded with a vinyl record;

a driving device for driving rotation of the turntable unit;

a record reading device operably associated with the vinyl record on the turntable unit for generating an analog audio output corresponding to analog audio data recorded in and read from the vinyl record;

an analog-to-digital converter coupled to the record reading device for converting the analog audio output therefrom into first audio output data in a digital form;

a disc reading device mounted in the housing, adapted to be loaded with an optical recording medium, and operably associated with the optical recording medium for generating second audio output data corresponding to digital audio data recorded in and read from the optical recording medium;

a first pick-up device operably associated with the vinyl record on the turntable unit so as to generate a first control signal representative of angular velocity and rotational direction of the vinyl record relative to the housing;

a control unit mounted in the housing and coupled to the driving device, the first pick-up device, the disc reading device and the analog-to-digital converter; and

an output port mounted on the housing and coupled to the control unit;

the control unit being operable in a selected one of a first mode, where the control unit enables the driving device to drive rotation of the turntable unit such that the first audio output data generated from the analog-to-digital converter and corresponding to the analog audio data read from the vinyl record on the turntable unit is outputted at the output port, and a second mode, where the control unit enables the disc reading device to output the second audio output data corresponding to the digital audio data read from the optical recording medium at the output port;

wherein manual rotation of the vinyl record on the turntable unit relative to the housing while the control unit operates in the second mode results in generation of the first control signal by the first pick-up device that is provided to the control unit;

the control unit being responsive to the first control signal when operated in the second mode so as to control reading of the digital audio data from the optical recording medium in order to impart a scratch effect to the second audio output data generated at the output port.

### BRIEF DESCRIPTION OF THE DRAWINGS

Other features and advantages of the present invention will become apparent in the following detailed description of the preferred embodiments with reference to the accompanying drawings, of which:

FIG. 1 illustrates a conventional analog audio playback apparatus;

FIG. 2 illustrates a conventional digital audio playback apparatus;

FIG. 3 is a schematic circuit block diagram illustrating a conventional digital and analog audio playback apparatus;

FIG. 4 illustrates a conventional digital and analog audio playback apparatus that incorporates the conventional analog audio playback apparatus of FIG. 1 and the conventional digital audio playback apparatus of FIG. 2;

FIG. 5 is a perspective view showing the first preferred embodiment of a digital and analog audio playback apparatus according to the present invention;

FIG. 6 is a schematic circuit block diagram illustrating the first preferred embodiment;

FIG. 7 is a perspective view showing the second preferred embodiment of a digital and analog audio playback apparatus according to the present invention;

FIG. 8 is a schematic circuit block diagram illustrating the second preferred embodiment;

FIG. 9 is a schematic circuit block diagram illustrating the third preferred embodiment of a digital and analog audio playback apparatus according to the present invention;

FIG. 10 is a perspective view showing the fourth preferred embodiment of a digital and analog audio playback apparatus according to the present invention; and

FIG. 11 is a schematic circuit block diagram illustrating the fourth preferred embodiment.

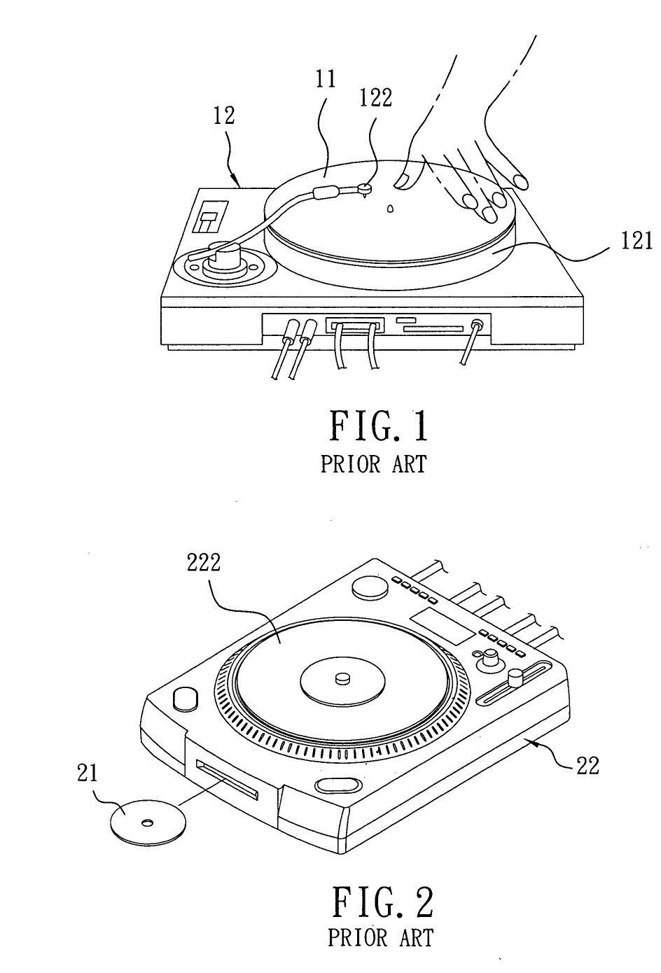

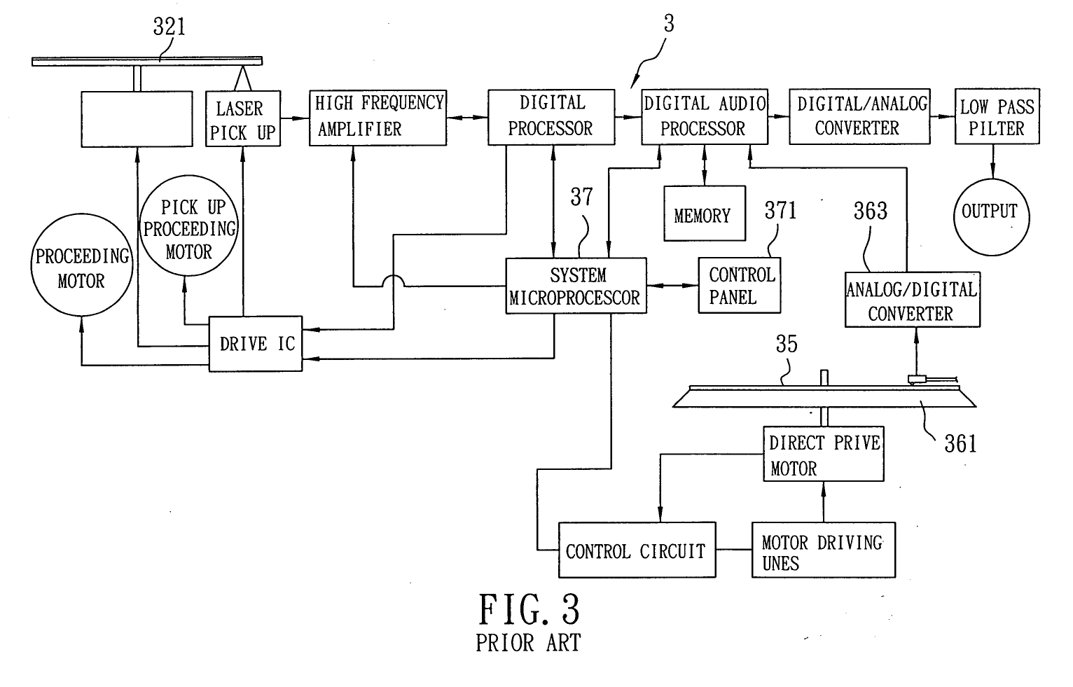

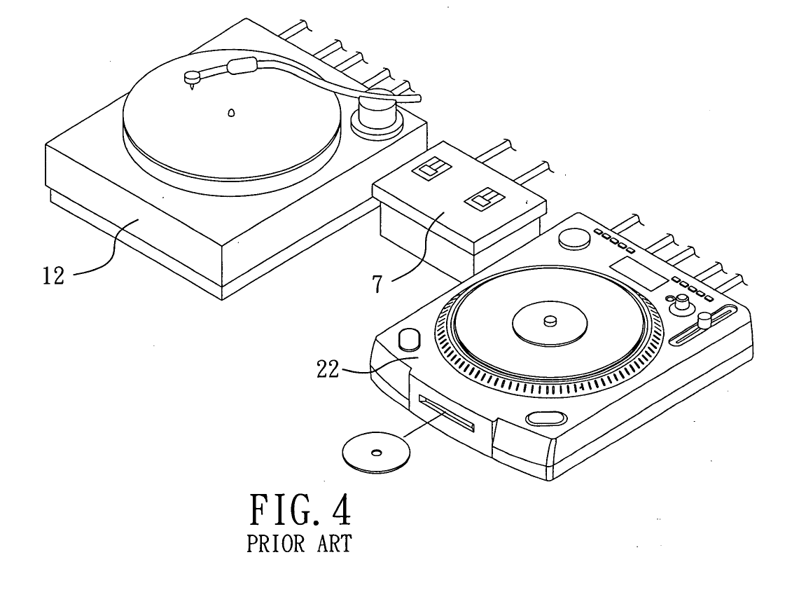

### DETAILED DESCRIPTION OF THE PREFERRED EMBODIMENTS

Before the present invention is described in greater detail, it should be noted that like elements are denoted by the same reference numerals throughout the disclosure.

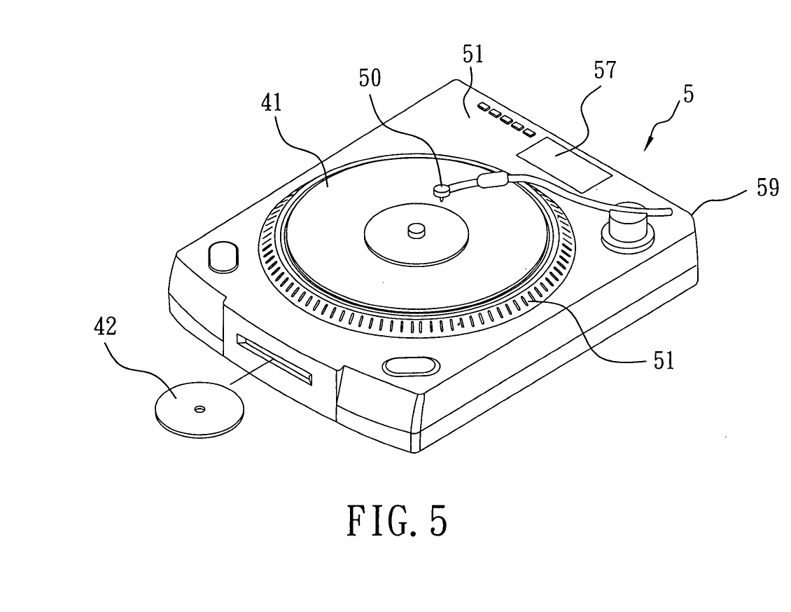

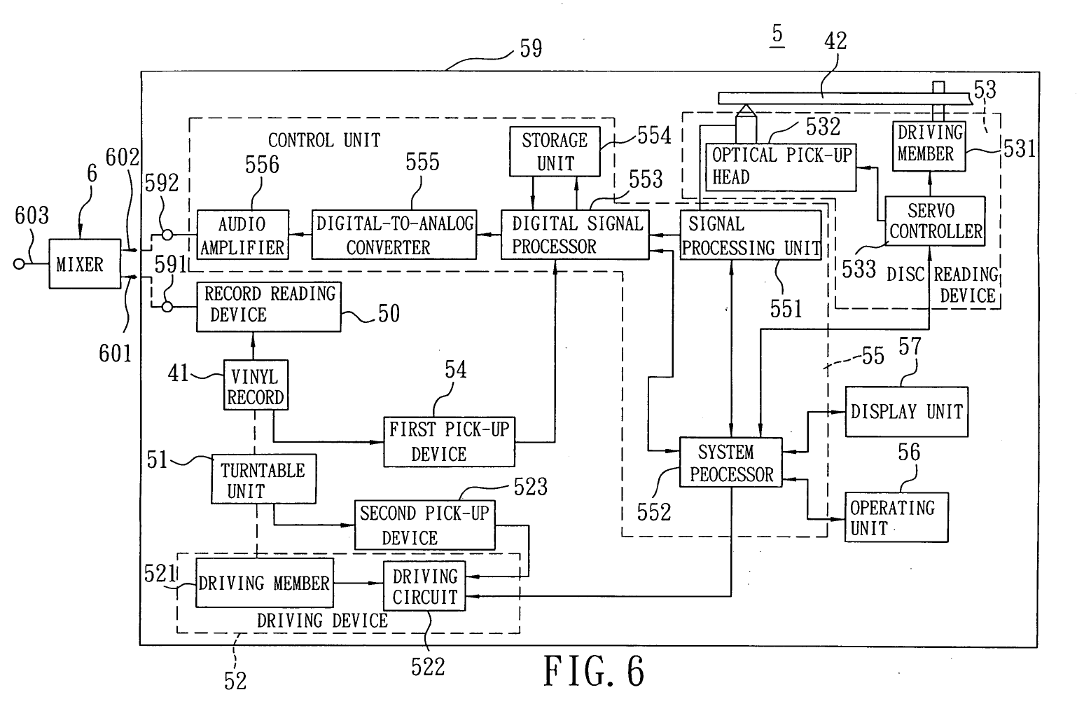

Referring to FIGS. 5 and 6, the first preferred embodiment of a digital and analog audio playback apparatus 5 according to the present invention is shown to include a housing 59, a turntable unit 51, a driving device 52, a record reading device 50, a disc reading device 53, a first pick-up device 54, a control unit 55, a first output port 591, a second output port 592, an operating unit 56, a display unit 57, and a second pick-up device 523.

The turntable unit 51 is mounted on the housing 59, and is adapted to be loaded with a vinyl record 41.

In this embodiment, the driving device 52 includes a driving circuit 522 and a driving member 521. The driving circuit 522 is capable of controlling the driving member 521 so as to drive rotation of the turntable unit 51 in a known manner.

The record reading device 50 is operably associated with the vinyl record 41 on the turntable unit 51 for generating first audio output data corresponding to analog audio data recorded in and read from the vinyl record 41 in a conventional manner.

The disc reading device 53 is mounted in the housing 59, is adapted to be loaded with an optical recording medium 42, such as an optical disc, and is operably associated with the optical recording medium 42 for generating second audio output data corresponding to digital audio data recorded in and read from the optical recording medium 42 in a conventional manner. In this embodiment, the disc reading device 53 includes an optical pick-up head 532 capable of reading data recorded in the optical recording medium 42, a driving member 531, and a servo controller 533 coupled to the optical pick-up head 532 and the driving member 531 for controlling movement of the optical pick-up head 53 and the driving member 531 when reading the data recorded in the optical recording medium 42 in a conventional manner.

The first pick-up device 54 is operably associated with the vinyl record 41 on the turntable unit 51 so as to generate a first control signal representative of angular velocity and rotational direction of the vinyl record 41 relative to the housing 59.

The control unit 55 is mounted in the housing 59, and is coupled to the driving device 52, the first pick-up device 54 and the disc reading device 53. In this embodiment, the control unit 55 includes a signal processing unit 551 coupled to the optical pick-up head 532, a system processor 552 coupled to the signal processing unit 551, a digital signal processor 553 coupled to the signal processing unit 551, the system processor 552 and the first pick-up device 54, a storage unit 554 coupled to the digital signal processor 553, a digital-to-analog converter 555 coupled to the digital signal processor 553, and an audio amplifier 556 coupled to the digital-to-analog converter 555. The storage unit 554 serves as a buffer for data read from the optical recording medium 42.

The first output port 591 is mounted on the housing 59, is coupled to the record reading device 50, and is adapted to be coupled to a sound amplifying system or a loudspeaker (not shown).

The second output port 592 is mounted on the housing 59, is coupled to the audio amplifier 556 of the control unit 55, and is adapted to be coupled to a sound amplifying system or a loudspeaker (not shown).

The control unit 55 is operable in a selected one of a first mode, where the system processor 552 of the control unit 55 enables the driving device 52 to drive rotation of the turntable unit 51 such that the record reading device 50 outputs the first audio output data corresponding to the analog audio data read from the vinyl record 41 on the turntable unit 51 at the first output port 591, and a second mode, where the system processor 552 of the control unit 55 enables the disc reading device 53 so as to output the second audio output data corresponding to the digital audio data read from the optical recording medium 42 at the second output port 592. In particular, when the control unit 55 is operated in the second mode, data read from the optical recording medium 42 is first buffered by the storage unit 554. The digital signal processor 553 then reads the contents of the storage unit 554, and the contents read from the storage unit 554 are further processed by the digital-to-analog converter 555 and the audio amplifier 556 to result in the second audio output data.

In this embodiment, manual rotation of the vinyl record 41 on the turntable unit 51 relative to the housing 59 while the control unit 55 operates in the second mode results in generation of the first control signal by the first pick-up device 54 that is provided to the digital signal processor 553 of the control unit 55. The digital signal processor 553 is responsive to the first control signal when operated in the second mode so as to control reading of the digital audio data from the optical recording medium 42 (i.e., reading of the buffered data of the storage unit 554) in order to impart a scratch effect to the second audio output data generated at the second output port 592.

The operating unit 56 is mounted on the housing 59, is coupled to the system processor 552 of the control unit 55, and is manually operable so as to enable the control unit 55 to operate in the selected one of the first and second modes.

The display unit 57 is mounted on the housing 59, and is coupled to and controlled by the system processor 552 of the control unit 55 so as to display status information during operation of the control unit 55 in the selected one of the first and second modes.

The second pick-up device 523 is coupled to the driving circuit 522 of the driving device 52, and is operably associated with the turntable unit 51 so as to generate a second control signal representative of angular velocity and rotational direction of the turntable unit 51. As such, the driving circuit 522 can control rotation of the turntable unit 51 in accordance with the second control signal so as to maintain normal rotational speed of the turntable unit 51.

In this embodiment, the control unit 55 is further operable in a third mode, where the control unit 55 enables the driving device 52 to drive rotation of the turntable unit 51 such that the record reading device 50 outputs the first audio output data corresponding to the analog audio data read from the vinyl record 41 on the turntable unit 51 at the first output port 591, and where the control unit 55 further enables the disc reading device 53 to output the second audio output data corresponding to the digital audio data read from the optical recording medium 42 at the second output port 592. By externally coupling first and second input ports 601, 602 of a mixer 6 to the first and second output ports 591, 592, a mixed audio output of the first and second audio output data can be generated at a third output port 603 of the mixer 6 in a conventional manner. It is noted that, when the control unit 55 is operated in the third mode, the mixed audio output can contain the first audio output data that is imparted with a scratch effect due to manually controlled rotation of the vinyl record 41 on the turntable unit 51, and the second audio output data that is not imparted with a scratch effect (i.e., generation of the first control signal by the first pick-up device 54 does not result in the imparting of the scratch effect to the second audio output data when the control unit is operated in the third mode).

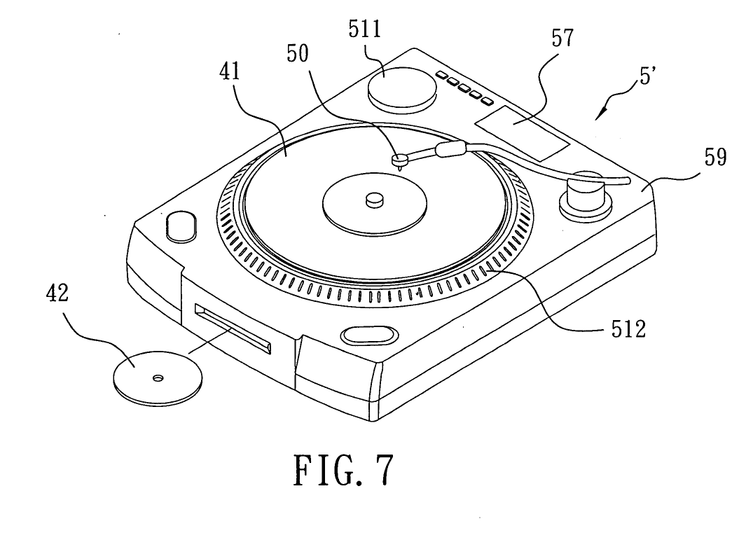

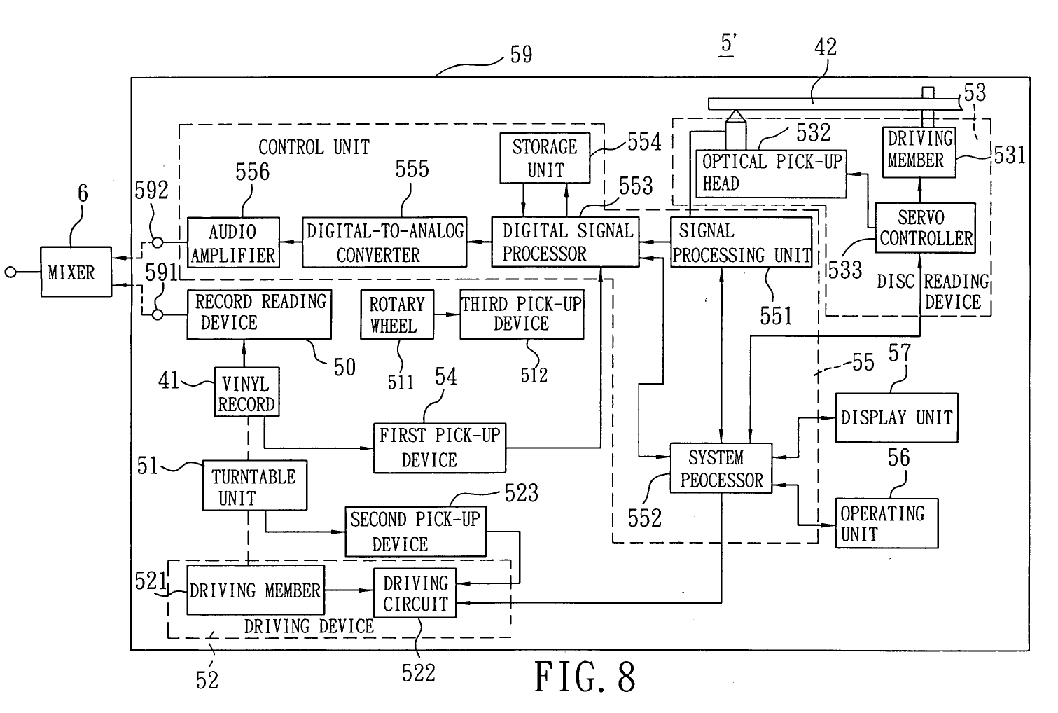

FIGS. 7 and 8 illustrate the second preferred embodiment of a digital and audio playback apparatus 5′ according to this invention, which is a modification of the first preferred embodiment. In this embodiment, the digital and audio playback apparatus 5′ further includes a manually-operable rotary wheel 511, and a third pick-up device 512.

The rotary wheel 511 is mounted rotatably on the housing 59, as shown in FIG. 7.

The third pick-up device 512 is coupled to the digital signal processor 553 of the control unit 55, and is operably associated with the rotary wheel 511 so as to generate a third control signal representative of angular velocity and rotational direction of the rotary wheel 511.

Unlike the first preferred embodiment, when the control unit 55 is operated in the third mode, the digital signal processor 553 is further responsive to the third control signal from the third pick-up device 512 so as to control reading of the digital audio data from the optical recording medium 42 (i.e., reading of the buffered data of the storage unit 554) in order to impart a scratch effect to the second audio output data generated at the second output port 592. Therefore, in this embodiment, when the control unit 55 is operated in the third mode, the mixed audio output can contain the first audio output data that is imparted with a scratch effect due to manually controlled rotation of the vinyl record 41 on the turntable unit 51, and the second audio output data that is also imparted with a scratch effect as a result of generation of the third control signal by the third pick-up device 512.

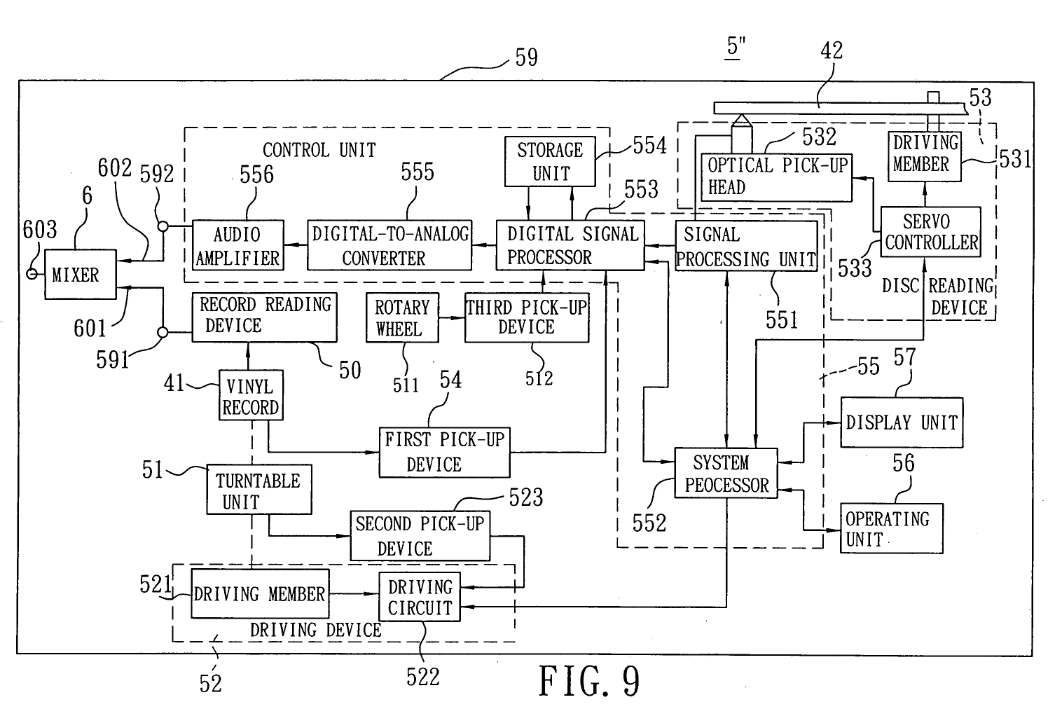

FIG. 9 illustrates the third preferred embodiment of a digital and audio playback apparatus 5″ according to this invention, which is a modification of the second preferred embodiment. In this embodiment, the digital and audio playback apparatus 5″ further includes a mixer 6′. The mixer 6′ is mounted in the housing 59, has first and second input ports 601, 602 coupled respectively to the first and second output ports 591, 592 for receiving the first and second audio output data therefrom, and a third output port 603 mounted on the housing 59.

When the control unit 55 is operated in the third mode, the mixer 6′ generates a mixed audio output of the first and second audio output data at the third output port 603.

It is noted that the first preferred embodiment may be further modified such that the first pick-up device 54 is replaced by the rotary wheel 511 and the third pick-up device 512 of the second preferred embodiment. Hence, when the control unit 55 is operated in the second mode, and the pick-up device 5-12 generates a control signal in response to manual rotation of the rotary wheel 511, the digital signal processor 553 responds to the control signal from the pick-up device 512 so as to control reading of the digital audio data from the optical recording medium 42 (i.e., reading of the buffered data of the storage unit 554) in order to impart a scratch effect to the second audio output data generated at the second output port 592.

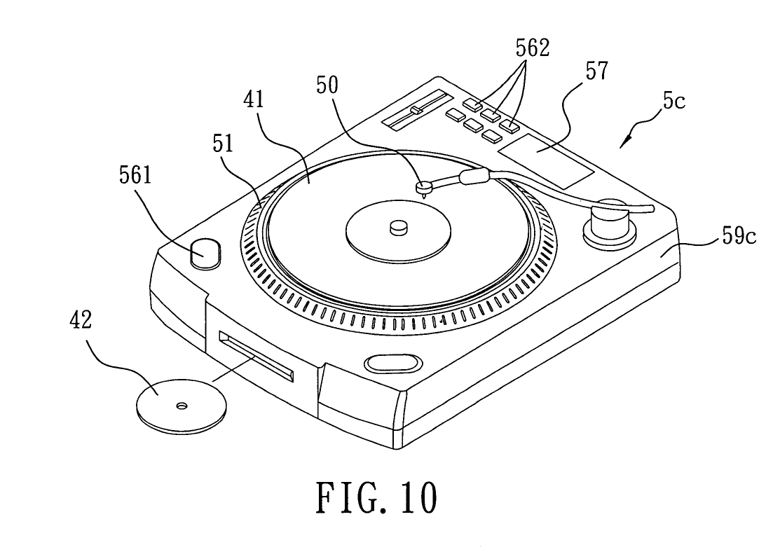

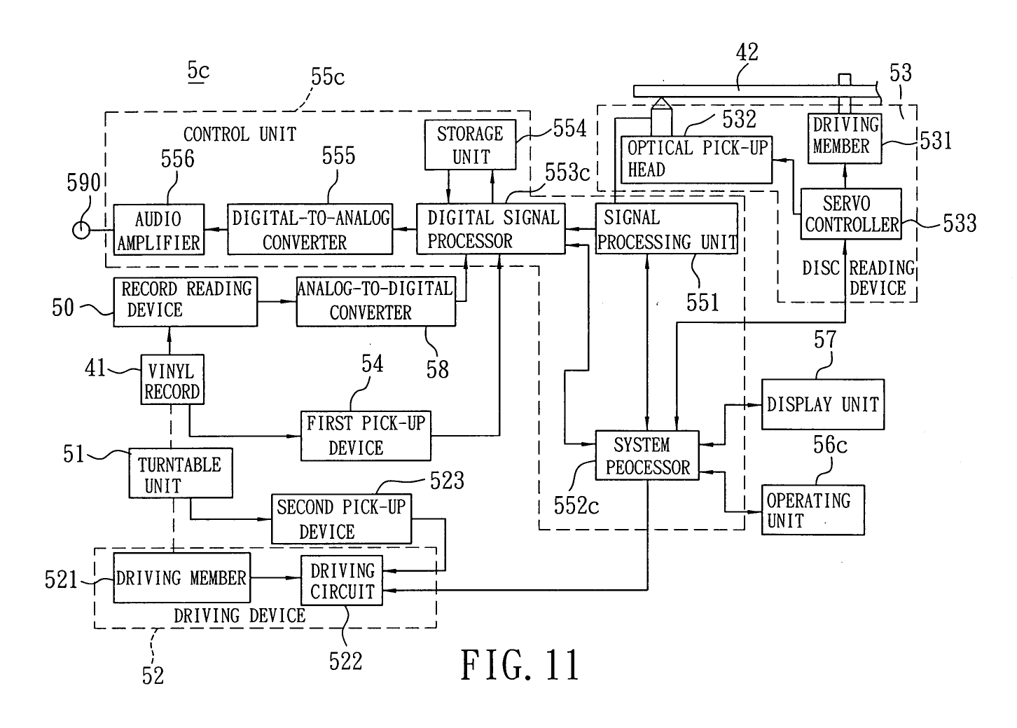

Referring to FIGS. 10 and 11, the fourth preferred embodiment of a digital and analog audio playback apparatus (5c) according to the present invention is shown to include a housing (59c) , a turntable unit 51, a driving device 52, a record reading device 50, an analog-to-digital converter 58, a disc reading device 53, a first pick-up device 54, a control unit (55c), an output port 590, an operating unit (56c), a display unit 57, and a second pick-up device 523.

The turntable unit 51 is mounted on the housing (59c) and is adapted to be loaded with a vinyl record 41.

In this embodiment, the driving device 52 includes a driving circuit 522 and a driving member 521. The driving circuit 522 is capable of controlling the driving member 521 so as to drive rotation of the turntable unit 51 in a known manner.

The record reading device 50 is operably associated with the vinyl record 41 on the turntable unit 51 for generating an analog audio output corresponding to analog audio data recorded in and read from the vinyl record 41 in a conventional manner.

The analog-to-digital converter 58 is coupled to the record reading device 50 for converting the analog audio output therefrom into first audio output data in a digital form.

The disc reading device 53 is mounted in the housing (59c), is adapted to be loaded with an optical recording medium 42, such as an optical disc, and is operably associated with the optical recording medium 42 for generating second audio output data corresponding to digital audio data recorded in and read from the optical recording medium 42 in a conventional manner. In this embodiment, the disc reading device 53 includes an optical pick-up head 532 capable of reading data recorded in the optical recording medium 42, a driving member 531, and a servo controller 533 coupled to the optical pick-up head 532 and the driving member 531 for controlling movement of the optical pick-up head 53 and the driving member 531 when reading the data recorded in the optical recording medium 42 in a conventional manner.

The first pick-up device 54 is operably associated with the vinyl record 41 on the turntable unit 51 so as to generate a first control signal representative of angular velocity and rotational direction of the vinyl record 41 relative to the housing (59c).

The control unit (55c) is mounted in the housing (59c), and is coupled to the driving device 52, the first pick-up device 54, the disc reading device 53 and the analog-to-digital converter 58. In this embodiment, the control unit (55c) includes a signal processing unit 551 coupled to the optical pick-up head 532, a system processor (552c) coupled to the signal processing unit 551, a digital signal processor (553c) coupled to the signal processing unit 551, the system processor (552c), the analog-to-digital converter 58 and the first pick-up device 54, a storage unit 554 coupled to the digital signal processor (553c) , a digital-to-analog converter 555 coupled to the digital signal processor (553c) , and an audio amplifier 556 coupled to the digital-to-analog converter 555. The storage unit 554 serves as a buffer for data read from the optical recording medium 42.

The output port 590 is mounted on the housing (59c), is coupled to the audio amplifier 556 of the control unit (55c), and is adapted to be coupled to a sound amplifying system or a loudspeaker (not shown).

The control unit (55c) is operable in a selected one of a first mode, where the system processor (552c) of the control unit (55c) enables the driving device 52 to drive rotation of the turntable unit 51 such that the first audio output data generated from the analog-to-digital converter 58 and corresponding to the analog audio data read from the vinyl record 41 on the turntable unit 51 is outputted at the output port 590, and a second mode, where the system processor (552c) of the control unit (55c) enables the disc reading device 53 so as to output the second audio output data corresponding to the digital audio data read from the optical recording medium 42 at the output port 590. In particular, when the control unit (55c) is operated in the second mode, data read from the optical recording medium 42 is first buffered by the storage unit 554. The digital signal processor (553c) then reads the contents of the storage unit 554, and the contents read from the storage unit 554 are further processed by the digital-to-analog converter 555 and the audio amplifier 556 to result in the second audio output data.

In this embodiment, manual rotation of the vinyl record 41 on the turntable unit 51 relative to the housing (59c) while the control unit (55c) operates in the second mode results in generation of the first control signal by the first pick-up device 54 that is provided to the digital signal processor (553c) of the control unit (55c) The digital signal processor (553c) is responsive to the first control signal when operated in the second mode so as to control reading of the digital audio data from the optical recording medium 42 (i.e., reading of the buffered data of the storage unit 554) in order to impart a scratch effect to the second audio output data generated at the output port 590.

The operating unit (56c) is mounted on the housing (59c), and is coupled to the system processor (552c) of the control unit (55c). In this embodiment, the operating unit (56c) includes a mode control key 561 (see FIG. 10) that is manually operable so as to enable the control unit (55c) to operate in the selected one of the first and second modes, and a set of digital sound effect control keys 562 (see FIG. 10), each of which is manually operable and capable of changing each of the first output data and the second audio output data in the digital signal processor 553c into the corresponding sound effect audio output data.

The display unit 57 is mounted on the housing (59c), and is coupled to and controlled by the system processor (552c) of the control unit (55c) so as to display status information during operation of the control unit (55c) in the selected one of the first and second modes.

The second pick-up device 523 is coupled to the driving circuit 522 of the driving device 52, and is operably associated with the turntable unit 51 so as to generate a second control signal representative of angular velocity and rotational direction of the turntable unit 51. As such, the driving circuit 522 can control rotation of the turntable unit 51 in accordance with the second control signal so as to maintain normal rotational speed of the turntable unit 51.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A digital and analog audio playback apparatus comprising:
a housing;
a turntable unit mounted on said housing and adapted to be loaded with a vinyl record;
a driving device for driving rotation of said turntable unit;
a record reading device operably associated with the vinyl record on said turntable unit for generating first audio output data corresponding to analog audio data recorded in and read from the vinyl record;
a disc reading device mounted in said housing, adapted to be loaded with an optical recording medium, and operably associated with the optical recording medium for generating second audio output data corresponding to digital audio data recorded in and read from the optical recording medium;
a first pick-up device operably associated with the vinyl record on said turntable unit so as to generate a first control signal representative of angular velocity and rotational direction of the vinyl record relative to said housing;
a control unit mounted in said housing and coupled to said driving device, said first pick-up device and said disc reading device;
a first output port mounted on said housing and coupled to said record reading device; and
a second output port mounted on said housing and coupled to said control unit;
said control unit being operable in a selected one of a first mode, where said control unit enables said driving device to drive rotation of said turntable unit such that said record reading device outputs the first audio output data corresponding to the analog audio data read from the vinyl record on said turntable unit at said first output port, and a second mode, where said control unit enables said disc reading device so as to output the second audio output data corresponding to the digital audio data read from the optical recording medium at said second output port.

2. The digital and analog audio playback apparatus as claimed in claim 1, further comprising an operating unit mounted on said housing, coupled to said control unit, and manually operable so as to enable said control unit to operate in the selected one of the first and second modes.

3. The digital and analog audio playback apparatus as claimed in claim 1, further comprising a display unit mounted on said housing, and coupled to and controlled by said control unit so as to display status information during operation of said control unit in the selected one of the first and second modes.

4. The digital and analog audio playback apparatus as claimed in claim 1, further comprising a second pick-up device coupled to said driving device and operably associated with said turntable unit so as to generate a second control signal representative of angular velocity and rotational direction of said turntable unit,
said control unit controlling said driving device to drive rotation of said turntable unit in accordance with the second control signal.

5. The digital and analog audio playback apparatus as claimed in claim 1, further comprising a mixer having first and second input ports coupled respectively to said first and second output ports, and at least a output port.

6. The digital and analog audio playback apparatus as claimed in claim 5, further comprising:
a manually-operable rotary wheel mounted rotatably on said housing; and
a third pick-up device coupled to said control unit and operably associated with -said rotary wheel so as to generate a control signal representative of angular velocity and rotational direction of said rotary wheel.

7. A digital and analog audio playback apparatus comprising:
a housing;
a turntable unit mounted on said housing and adapted to be loaded with a vinyl record;
a driving device for driving rotation of said turntable unit;
a record reading device operably associated with the vinyl record on said turntable unit for generating first audio output data corresponding to analog audio data recorded in and read from the vinyl record;
a disc reading device mounted in said housing, adapted to be loaded with an optical recording medium, and operably associated with the optical recording medium for generating second audio output data corresponding to digital audio data recorded in and read from the optical recording medium;
a manually-operable rotary wheel mounted rotatably on said housing;
a pick-up device operably associated with said rotary wheel so as to generate a control signal representative of angular velocity and rotational direction of said rotary wheel relative to said housing;
a control unit mounted in said housing and coupled to said driving device, said pick-up device and said disc reading device;
a first output port mounted on said housing and coupled to said record reading device; and
a second output port mounted on said housing and coupled to said control unit;
said control unit being operable in a selected one of a first mode, where said control unit enables said driving device to drive rotation of said turntable unit such that said record reading device outputs the first audio output data corresponding to the analog audio data read from the vinyl record on said turntable unit at said first output port, and a second mode, where said control unit enables said disc reading device so as to output the second audio output data corresponding to the digital audio data read from the optical recording medium at said second output port.

8. A digital and analog audio playback apparatus comprising:
a housing;
a turntable unit mounted on said housing and adapted to be loaded with a vinyl record;
a driving device for driving rotation of said turntable unit;
a record reading device operably associated with the vinyl record on said turntable unit for generating an analog audio output corresponding to analog audio data recorded in and read from the vinyl record;
an analog-to-digital converter coupled to said record reading device for converting the analog audio output therefrom into first audio output data in a digital form;
a disc reading device mounted in said housing, adapted to be loaded with an optical recording medium, and operably associated with the optical recording medium for generating second audio output data corresponding to digital audio data recorded in and read from the optical recording medium;
a first pick-up device operably associated with the vinyl record on said turntable unit so as to generate a first control signal representative of angular velocity and rotational direction of the vinyl record relative to said housing;
a control unit mounted in said housing and coupled to said driving device, said first pick-up device, said disc reading device and said analog-to-digital converter; and
an output port mounted on said housing and coupled to said control unit;
said control unit being operable in a selected one of a first mode, where said control unit enables said driving device to drive rotation of said turntable unit such that the first audio output data generated from said analog-to-digital converter and corresponding to the analog audio data read from the vinyl record on said turntable unit is outputted at said output port, and a second mode, where said control unit enables said disc reading device to output the second audio output data corresponding to the digital audio data read from the optical recording medium at said output port.

9. The digital and analog audio playback apparatus as claimed in claim 8, further comprising an operating unit mounted on said housing, coupled to said control unit, and manually operable so as to enable said control unit to operate in the selected one of the first and second modes.

10. The digital and analog audio playback apparatus as claimed in claim 8, further comprising a display unit mounted on said housing, and coupled to and controlled by said control unit so as to display status information during operation of said control unit in the selected one of the first and second modes.

11. The digital and analog audio playback apparatus as claimed in claim 8, further comprising a second pick-up device coupled to said driving device and operably associated with said turntable unit so as to generate a second control signal representative of angular velocity and rotational direction of said turntable unit,
said control unit controlling said driving device to drive rotation of said turntable unit in accordance with the second control signal.
